(19) United States
(12) Patent Application Publication
(10) Pub. No.: US 2017/0302577 A1
(43) Pub. Date: Oct. 19, 2017

(54) FORWARDING PORT ASSIGNMENT FOR DATA PACKET

(71) Applicant: Hewlett Packard Enterprise Development LP, Houston, TX (US)

(72) Inventors: Kevin M. WORTH, Roseville, CA (US); Shawn E. REYNOLDS, Roseville, CA (US); Jay G. SCHUDEL, Roseville, CA (US)

(21) Appl. No.: 15/507,376

(22) PCT Filed: Apr. 30, 2015
(86) PCT No.: PCT/US2015/028399

§ 371 Date: Feb. 28, 2017

(51) Int. Cl. H04L 12/743; H04L 12/803

(52) U.S. Cl. CPC H04L 45/7453; H04L 45/7457; H04L 47/125

(57) ABSTRACT

In some examples, a method includes determining a hash value for a received data packet, determining whether the determined hash value matches a hash value for an entry in a hash-to-port mapping table, determining whether a port mapping age associated with the matched entry satisfies an age criteria, and assigning a forwarding port for the received data packet based on the determination of whether the port mapping age associated with the matched entry satisfies the age criteria.

### BACKGROUND

Computer networks can be used to allow networked devices, such as personal computers, servers, and data storage devices to exchange data. Computer networks often include intermediary datapath devices such as network switches, gateways, and routers, to flow traffic along selected data routing paths between networked devices. A data routing path can, for example, be selected by a network controller, administrator, or another entity, and can, for example, be based on network conditions, network equipment capabilities, or other factors.

### BRIEF DESCRIPTION OF THE DRAWINGS

For a detailed description of various examples, reference will now be made to the accompanying drawings in which:

FIG. 1 is a diagram of a network, according to an example.

FIG. 2 is a flowchart for a method, according to an example.

FIG. 3 is a flowchart for a method, according to another example.

FIG. 4 is a flowchart for a method, according to another example.

FIG. 5 is a diagram of a system, according to an example.

FIG. 6 is a diagram of a machine-readable storage medium, according to an example.

FIG. 7 is a flowchart for a method, according to another example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

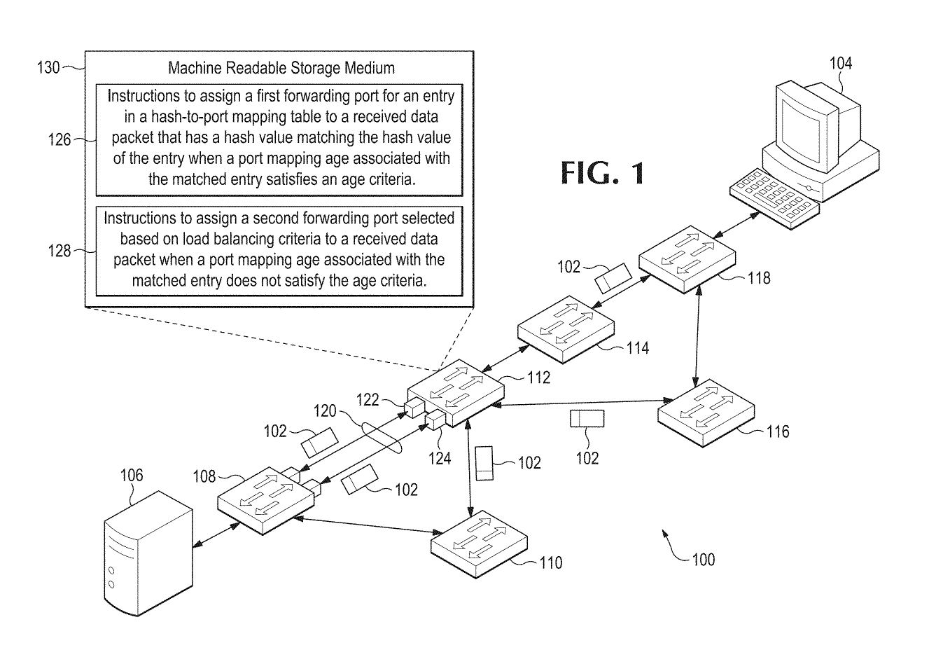

Network load balancing may be performed by applying a hash function on data in each network data packet received at a network switch or another type of datapath forwarding device in a network. For example, a data packet can be balanced based on its “5-tuple” data, which can, for example, include information indicating the data packet's source and destination Internet Protocol (IP) address, transport protocol, and Transmission Control Protocol/User Datagram Protocol (TCP/UDP) source and destination port. The result of this hashing operation can be used to map the data packet to a fixed set of resources, such as a number of physical ports in a Link Aggregation Group (LAG), which can, for example, be considered a logical connection consisting of more than one physical connections (and is described in further detail below with respect to the network of FIG. 1. Given a sufficiently large number of flows, a hash function may be able to produce a statistically even distribution of traffic across physical links in the LAG.

Although many networks and protocols may define their behavior as “best effort” (e.g., making no guarantees about in-order delivery of packets), devices and systems can in many situations work best when packets are delivered in the order they were transmitted. Such in-order delivery can be ensured by maintaining flow affinity, i.e., sending all packets belonging to a given flow via the same network path (e.g., all packets having the same 5-tuple all travel the same path, therefore the network device sees all packets that are part of the same network flow in order). As an example, certain networking devices (for example security products, such as Intrusion Prevention Systems) may work best when flow affinity is maintained. In networks that include LAGs to provide redundancy and increased bandwidth, security devices may work best when flow affinity is maintained even as LAG events (e.g., individual physical links being added, removed, enabled, or disabled) occur.

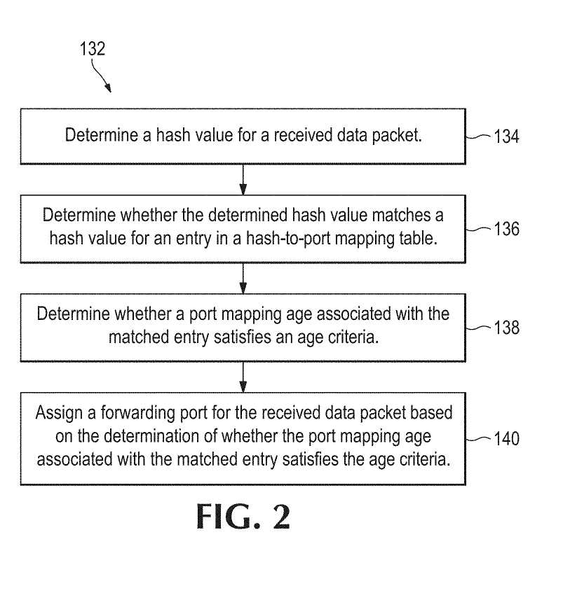

Certain implementations of the present disclosure attempt to solve the problem of performing network load balancing in a manner that is both highly scalable and maintains flow affinity without tracking individual flow states. In one implementation, a method in accordance with the present disclosure can include: (1) determining a hash value for a received data packet, (2) determining whether the determined hash value matches a hash value for an entry in a hash-to-port mapping table, (3) determining whether a port mapping age associated with the matched entry satisfies an age criteria, and (4) assigning a forwarding port for the received data packet based on the determination of whether the port mapping age associated with the matched entry satisfies the age criteria. This method is described in further detail below with respect to FIG. 2.

Certain implementations of the present disclosure can provide advantages compared to present systems for load balancing in networks. For example, with certain existing load balancing systems, network equipment manufacturers and their customers may be faced with a trade-off between cost (e.g., monetary or performance) and functionality (e.g., maintaining flow affinity). A customer who makes a choice to prioritize low cost at the expense of flow affinity may not be getting the full functionality of their network security devices that rely on flow affinity to provide optimal network security analysis. A customer who makes a choice to prioritize flow affinity at a higher cost could face financial challenges when justifying the equipment's purchase or be required to accept limitations on the throughput/performance capabilities of the device since it could be ensuring flow affinity using slower software to reduce its purchase price. Certain implementations of the present disclosure can allow network equipment manufacturers to scale a system's capability to meet customer expectations of cost and responsiveness of rebalancing. For example, a system with lower performance requirements could have less memory for its hash-to-port mapping table and therefore may be less responsive to take advantage of additional bandwidth (in the form of physical links) being added to LAGs. Other advantages of implementations presented herein will be apparent upon review of the description and figures.

FIG. 1 is a diagram of a simplified example network 100. In particular, FIG. 1 depicts traffic in the form of data packets 102 between source node 104 and destination node 106. Source node 104 is in data communication with destination node 106 via multiple intermediate network nodes 108, 110, 112, 114, 116, and 118 which can, for example and as described in further detail below, be in the form of network switches. The various nodes with network 100 are connected to each other via various wired or wireless data links.

Simplified example network 100 includes a LAG link 120, which is depicted as an oval between nodes 108 and 112 (i.e., LAG nodes 108 and 112). As provided above, a LAG link (e.g., LAG link 120) can, for example, be considered a logical connection consisting of more than one physical connections. For example, LAG link 120 can, for example, be in the form of multiple physical links between adjacent nodes in a network that are combined in order to increase throughput, provide redundancy, balance data traffic, and/or provide other properties to achieve desired performance. In some implementations, LAG node 112 (or another network device in communication with the LAG node and instructing the LAG node) can determine which physical sub-link of LAG link 120 to route traffic to the adjacent downstream node (e.g., LAG node 112).

Such a determination can, for example, be based on packet metadata and port selection logic for forwarding packet 102. In such an implementation, the port selection logic for forwarding packet 102 within LAG node 112 can, for example, reside within LAG node 112 itself and can, for example, be in the form of a hash of a set of parameters for a given packet, such as Media Access Control (MAC) address, Internet Protocol (IP) address, Transmission Control Protocol (TCP) port, User Datagram Protocol (UDP) port, etc. As a simple example, port selection logic stored locally on LAG node 112 can instruct a processing resource of LAG node 112 to check whether packet 102 was received via a specific ingress port and, if so, to forward packet 102 along a specific sub-link of LAG link 120 to adjacent downstream LAG node 108 using a specific LAG forwarding port 122 or 124. Although only two LAG forwarding ports are illustrated for LAG node 112, it is appreciated that LAG node 112 may have any suitable number of LAG (or other) forwarding ports.

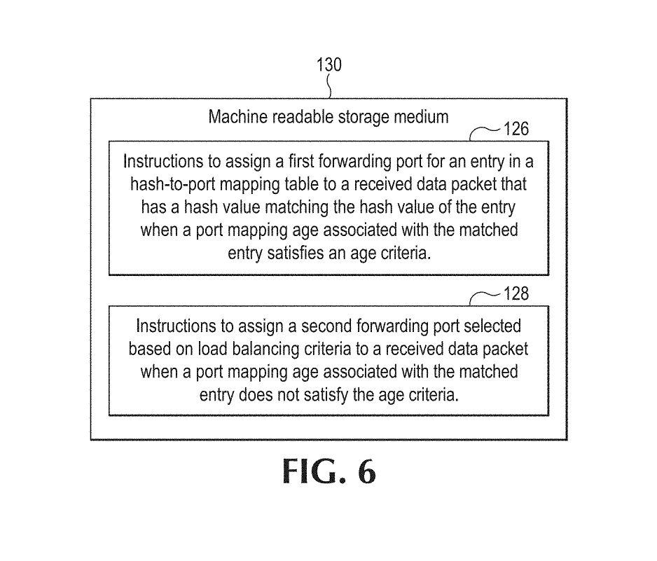

Other load balancing or data routing techniques can be used with LAG node 112. For example, as described in further detail below with respect to FIG. 6, a machine readable storage medium 130 of LAG node 112 can have stored thereon machine readable instructions to cause a computer processor or other processing resource of LAG node 112 to assign a first forwarding port 122 for an entry in a hash-to-port mapping table to a received data packet that has a hash value matching the hash value of the entry when a port mapping age associated with the matched entry satisfies an age criteria (instructions 126) as well as instructions to assign a second forwarding port selected based on load balancing criteria to a received data packet when a port mapping age associated with the matched entry does not satisfy the age criteria (instructions 128). Further details regarding instructions 126 and 128 as well as medium 130 are provided below with respect to FIG. 6. Although this disclosure primarily refers to the use of 5-tuple data and LAGs as an example, the present disclosure can be used for any network load balancing technology where maintaining flow affinity without tracking flow state is desired.

Source node 104 and destination node 106 can, for example, be in the form of network hosts or other suitable types of network nodes. Only a single source node 104 and a single destination node 106 are illustrated in simplified example network 100. However, it is appreciated that different implementations of network 100 may include multiple source nodes 104 and multiple destination nodes 106. One or both of source node 104 and destination node 106 can be in the form of suitable servers, desktop computers, laptops, printers, etc. As but one example, source node 104 can be in the form of a desktop computer including a monitor for presenting information to an operator and a keyboard and mouse for receiving input from an operator, and destination node 106 can be in the form of a standalone storage server appliance. It is appreciated that the source and destination nodes can be in the form of endpoint nodes on network 100, intermediate nodes between endpoint nodes, or other types of network nodes. In the simplified example network 100 depicted in FIG. 1, the various network nodes are in the form of intermediary nodes and host devices. It is appreciated however, that the implementations described herein can be used or adapted for networks including more or fewer devices, different types of devices, and different network arrangements.

Nodes 108, 110, 112, 114, 116, and 118 can, for example, be in the form of switches or other multi-port network bridges that process and forward data at the data link layer. In some implementations, one or more of the nodes can be in the form of multilayer switches that operate at multiple layers of the OSI model (e.g., the data link and network layers). Although the term “switch” is used throughout this description, it is appreciated that this term can refer broadly to other suitable network data forwarding devices. For example, a general purpose computer can include suitable hardware and machine-readable instructions that allow the computer to function as a network switch. It is appreciated that the term “switch” can include other network data path elements in the form of suitable routers, gateways and other devices that provide switch-like functionality for network 100.

Nodes within network 100 can forward traffic along a datapath based on metadata within the traffic. For example, traffic received at the node can be in the form of a packet. For illustration, the term “packet” is used herein, however, it is appreciated that “packet” can refer to any suitable protocol data unit (PDU). The packet can, for example, include payload data as well as metadata in the form of control data. Control data can, for example, provide data to assist the node with reliably delivering the payload data. For example, control data can include network addresses for source and destination nodes, error detection codes, sequencing information, and packet size of the packet. In contrast, payload data can include data carried on behalf of an application for use by a source node or destination node.

Each node within network 100 can, for example, help manage the flow of data across a network by only transmitting a received message to a destination device for which the message was intended (or to an intermediary device en route to the destination device). In some implementations, such nodes can rely on flow entries in flow tables stored on a machine-readable medium within each switch (or otherwise accessible by each switch). Each flow entry in a flow table can, for example, contain information such as: (1) match fields to match against packets (e.g., an ingress port and specific packet header fields), (2) a priority value for the flow entry to allow prioritization over other flow entries, (3) counters that are updated when packets are matched, (4) instructions to modify the action set or pipeline processing, and (5) timeouts indicating a maximum amount of time or idle time before a flow is expired by the switch, and (6) a cookie value which can be used to filter flow statistics, flow modification, and flow deletion.

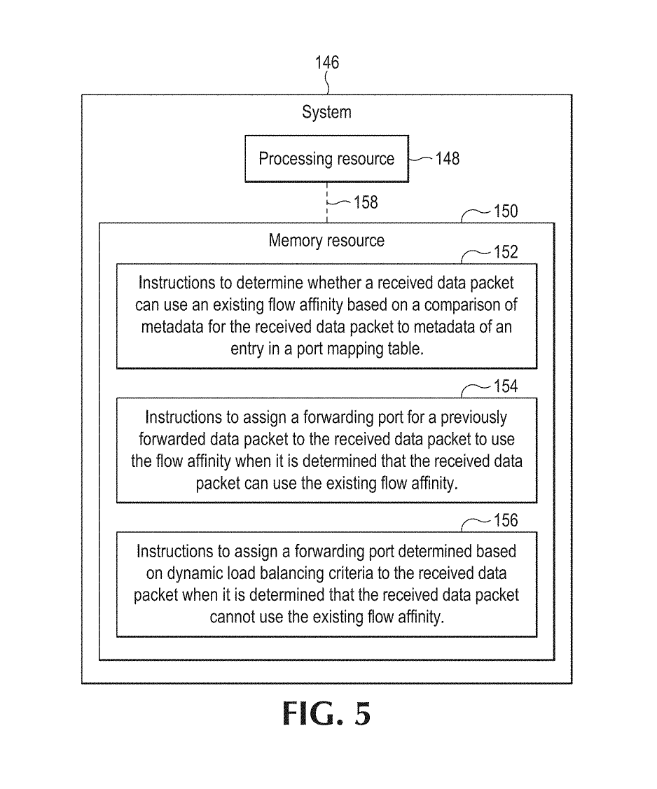

FIG. 2 is a flowchart for a method 132 implemented in LAG node 112 or another forwarding device to assign a forwarding port for a received data packet. For example, in some implementations, method 132 can be performed on a forwarding device, such as a LAG switch or other node (e.g., LAG node 112) as well as a network switch that may not provide LAG functionality (e.g., node 116). Method 132 illustrated in the flowchart of FIG. 2 as well as the methods described in the other figures can, for example, be implemented in the form of executable instructions stored on a memory resource (e.g., the memory resource of the system of FIG. 5), executable instructions stored on a storage medium (e.g., on medium 130 of FIG. 6), in the form of electronic circuitry, or another suitable form.

Method 132 includes a step 134 of determining a hash value for a received data packet. For example, in some implementations, a hash value can be determined for a received data packet by performing a hashing operation on metadata of the received data packet. The term “hashing operation” as used herein can, for example, refer to a function that can be used to map digital data of arbitrary size to digital data of fixed size. A value returned by such a hashing operation can be called a hash value, hash code, hash sum, etc. The use of such a hashing operation can, for example, be used to detect duplicated records in a large file. In some implementations, a hashing operation can be used to quickly locate a data record given its search key by mapping the search key to an index, with the index indicating the place in the hash table where the corresponding record should be stored. In some implementations, the metadata on which the hashing operation is performed can be in the form of a hash value based on Transmission Control Protocol/Internet Protocol (TCP/IP) routing information. It is appreciated that other control data may be used. In some implementations, the hashing operation can be performed on both metadata as well as the actual payload data of the received packet.

Method 132 includes a step 136 of determining whether the determined hash value matches a hash value for an entry in a hash-to-port mapping table. In some implementations, the hash-to-port mapping table can be stored in the form of a Ternary Content-Addressable Memory (TCAM). It is appreciated that the hash-to-port mapping table can be stored in another suitable form of memory on LAG node 112 or another device. The hash-to-port mapping table can, for example, include various fields for each entry, such as a hash value for the entry, a port mapping age entry (described in further detail below with respect to step 138 of method 132), which can for example indicate when the entry was last used, and a forwarding port assignment for the entry (described in further detail below with respect to step 140 of method 132). In some implementations, a strict comparison operation can be used to determine whether the determined hash value from step 136 matches a hash value for an entry in the hash-to-port mapping table (i.e., are the values identical). In some implementations, more advanced comparisons or criteria can be applied for determining whether the hash value determined in step 136 “matches” a hash value for an entry in the hash-to-port mapping table.

Method 132 includes a step 138 of determining whether a port mapping age associated with the matched entry satisfies an age criteria. The age criteria can, for example, be determined to provide flow affinity for data packets. For example, in some implementations, the port mapping age associated with a given entry in the hash-to-port mapping table can be a value indicating a period of time that has elapsed since a hash value for a received packet last matched a hash value in the hash-to-port mapping table for the given entry. In some implementations, the age criteria can be a simple comparison between the port mapping age and a threshold value. As an example, a value indicating the last time the hash-to-port mapping was used (e.g., 2015-01-01-13:25:04) can be subtracted from a time that the packet was received (e.g., 2015-01-01-13:27:32) and if the result is less than an age criteria (e.g., 10 minutes), then it is determined that the matched entry satisfies the age criteria.

It is appreciated that the determination of step 138 can be based on more advanced criteria than a simple comparison of values. For example, in some implementations, the age criteria can include multiple threshold values that can dynamically change based on time, network conditions, or other factors. The result of such a determination can be in the form of a bit indicator, such as for example a first bit value of 1 indicating that the port mapping age associated with the matched entry satisfies the age criteria and a second bit value of 0 indicating that the port mapping age associated with the matched entry does not satisfy the age criteria. Moreover, it is appreciated that the compared values can be based on a time value or parameter other than when the packet was received (e.g., the current system time or a predicted forwarding time).

Method 132 includes a step 140 of assigning a forwarding port for the received data packet based on the determination of whether the port mapping age associated with the matched entry satisfies the age criteria. For example, in situations where it is determined that the port mapping age associated with the matched entry satisfies the age criteria, the assigned forwarding port for the received data packet can be a forwarding port associated with the matched entry in the hash-to-port mapping table. In certain implementations, reliance on age criteria and using the same forwarding port as a recently forwarded packet can be used to preserve flow affinity for the received data packet.

In some implementations, in situations where it is determined that the port mapping age does not satisfy the age criteria, the assigned forwarding port for the received data packet can be selected from a plurality of forwarding ports for the forwarding device. The selection of such a forwarding port can, for example, be based on load balancing criteria. For example, in some implementations, node 112 can compare a load on first port 122 of node 112 to a load on second port 124 of node 112 and select the port with the smaller load. It is appreciated that more complicated techniques for load balancing and port selection can be used with the various implementations of the present disclosure. For example, because output ports may be selected less frequently than every received packet, step 140 can include selecting an output port based on link utilization, weighted distribution, round-robin, or any other selection criteria/algorithm. Furthermore step 140 can include computing a “next port” value asynchronously from the data path, which may avoid adding latency to a flow's initial packets while computations are performed.

Although the assigned forwarding port for the received data packet when the port mapping age associated with the matched entry satisfies the age criteria may be determined using a different technique than the assigned forwarding port for the matched entry when the port mapping age associated with the matched entry does not satisfy the age criteria, it is appreciated that the actual port selected using the respective techniques may be the same port. For example, first port 122 for a received data packet may be chosen based on load balancing criteria in a situation where the port mapping age does not satisfy the age criteria, whereas first port 122 may also have been the chosen port if the port mapping age did satisfy the age criteria. That is, in some implementations and for some specific packets and time conditions, it may be ultimately irrelevant whether the port mapping age actually satisfies the age criteria because both selection procedures result in the same forwarding port assigned to the received data packet.

In some implementations, even where it is determined that the port mapping age associated with the matched entry satisfies the age criteria, the assigned forwarding port for the received data packet may be different than the forwarding port associated with the matched entry in the hash-to-port mapping table. For example, in some situations, the forwarding port associated with the matched entry may have been removed or is otherwise inaccessible. In such a situation, the assigned forwarding port may be selected as if the port mapping age did not satisfy the age criteria, and can, for example, be based on load balancing criteria. Moreover, in such a situation, flow affinity is not expected (or desired, since the in-use link has been broken), so table entries containing the newly-removed link could have their port mapping removed to ensure the hash-to-port mapping would be reset to a physical link that is still active in the LAG.

In some implementations, when a hash-to-port mapping table is consulted and no physical link has been selected for that hash value, step 140 can include choosing from among currently-available physical ports (e.g., members of the LAG). This selection can, for example, be performed using a fixed configuration by the network administrator, be based on current utilization of the physical links, or using some other algorithm or process. Once the selection of a physical link is completed, the record would be created and a “last-used” value or other related value can be updated, for example, by setting the value to the current time (which could be measured in actual time, system clock cycles, or via some other method).

Although the flowchart of FIG. 2 and description of method 132 identifies one order of performance, it is appreciated that this order may be rearranged into another suitable order, may be executed concurrently or with partial concurrence, include additional or comparable steps to achieve the same or comparable functionality, or a combination thereof.

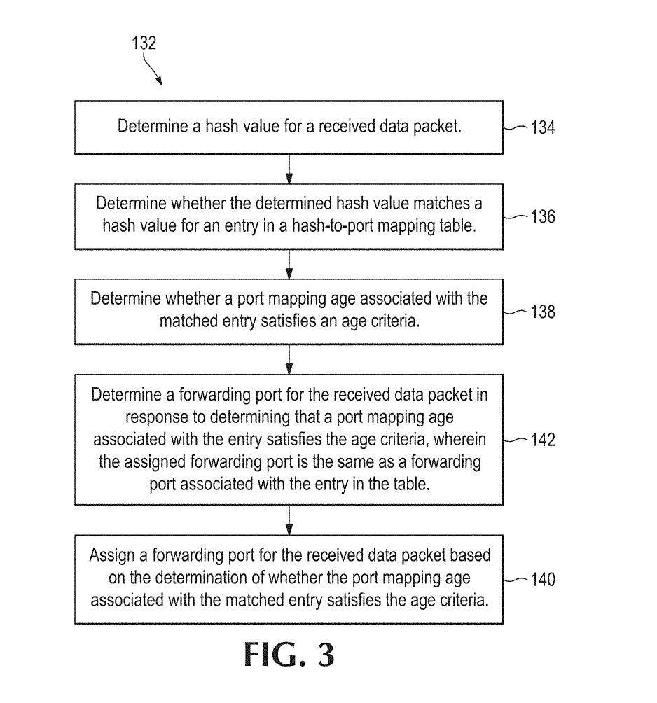

FIG. 3 illustrates another example of method 132 in accordance with the present disclosure. Method 132 of FIG. 3 expressly illustrates a step 142 of determining a forwarding port for the received data packet in response to determining that a port mapping age associated with the entry satisfies the age criteria, wherein the assigned forwarding port is the same as a forwarding port associated with the entry in the table. Further details regarding this step is described above with respect to step 140 of FIG. 2 but is expressly broken out as a separate step in FIG. 3.

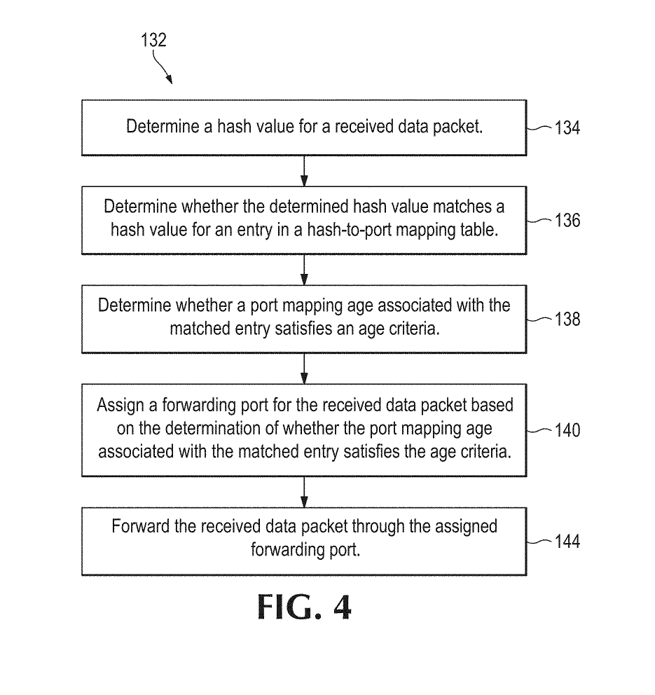

FIG. 4 illustrates another example of method 132 in accordance with the present disclosure. Method 132 includes a step 144 of actually forwarding the received data packet through the assigned forwarding port. In some implementations, and in addition to forwarding the received data packet, step 144 can, for example include a step of decrementing a time-to-live (TTL) field of the packet, and, if the new value is zero, discard the packet. It is appreciated that such an operation can be performed at another suitable time after receipt of the packet by the node. In some implementations, and in addition to forwarding the received data packet, step 144 can further include post-processing steps related to forwarding the data packet, such as data link encapsulation before sending the data packet out the assigned port.

FIG. 5 illustrates a diagram of a system 146 in accordance with the present disclosure. It is appreciated that system 146 can, for example, be in the form of a LAG node (e.g., LAG node 112) or a network switch or other forwarding device of a network (e.g., a node without LAG functionality, such as node 116) which receives and forwards a given data packet. In some implementations, system 146 can be remote to the forwarding device that actually receives and forwards the data packet. For example, in some implementations, system 146 can be in the form of a controller in wired or wireless communication with a remote LAG node 112 or another forwarding device.

As described in further detail below, system 146 includes a processing resource 148 and a memory resource 150 that stores machine-readable instructions that when executed by processing resource 148 are to determine whether a received data packet can use an existing flow affinity based on a comparison of metadata for the received data packet to metadata of an entry in a port mapping table (instructions 152), assign a forwarding port for a previously forwarded data packet to the received data packet to use the flow affinity when it is determined that the received data packet can use the existing flow affinity (instructions 154), and assign a forwarding port determined based on dynamic load balancing criteria to the received data packet when it is determined that the received data packet cannot use the existing flow affinity (instructions 156). The various aspects of system 146 including processing resource 148, memory resource 150, and instructions 152, 154, and 156 will be described in further detail below.

As provided above, instructions 152 stored on memory resource 150 are, when executed by processing resource 148, to cause processing resource 148 to determine whether a received data packet can use an existing flow affinity based on a comparison of metadata for the received data packet to metadata of an entry in a port mapping table. Instructions 152 can incorporate one or more aspects of steps 134, 136, and 138 or another suitable aspect of other implementations described herein (and vice versa). As but one example, in some implementations, instructions 152 can cause processing resource 148 to determine whether the received data packet can use an existing flow affinity based on a port mapping age of an entry in a port mapping table.

As provided above, instructions 154 stored on memory resource 150 are, when executed by processing resource 148, to cause processing resource 148 to assign a forwarding port for a previously forwarded data packet to the received data packet to use the flow affinity when it is determined that the received data packet can use the existing flow affinity. Instructions 154 can incorporate one or more aspects of steps 140 or another suitable aspect of other implementations described herein (and vice versa). As but one example, in some implementations, instructions 154 may not assign the same forwarding port for a previously forwarded data packet if the port has been removed or is otherwise available and can instead, for example, select or otherwise determine a different port for assignment.

As provided above, instructions 156 stored on memory resource 150 are, when executed by processing resource 148, to cause processing resource 148 to assign a forwarding port determined based on dynamic load balancing criteria to the received data packet when it is determined that the received data packet cannot use the existing flow affinity. Instructions 156 can incorporate one or more aspects of steps 140 or another suitable aspect of other implementations described herein (and vice versa). As but one example, in some implementations, instructions 156 can include selecting an output port based on link utilization of the available ports.

Processing resource 148 of system 146 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 150, or suitable combinations thereof. Processing resource 148 can, for example, include single or multiple cores on a chip, multiple cores across multiple chips, multiple cores across multiple devices, or suitable combinations thereof. Processing resource 148 can be functional to fetch, decode, and execute instructions as described herein. As an alternative or in addition to retrieving and executing instructions, processing resource 148 can, for example, include at least one integrated circuit (IC), other control logic, other electronic circuits, or suitable combination thereof that include a number of electronic components for performing the functionality of instructions stored on memory resource 150. Processing resource 148 can, for example, be implemented across multiple processing units and instructions may be implemented by different processing units in different areas of system 146.

Memory resource 150 of system 146 can, for example, be in the form of a non-transitory machine-readable storage medium, such as a suitable electronic, magnetic, optical, or other physical storage apparatus to contain or store information such as machine-readable instructions 152, 154, and 156. Such instructions can be operative to perform one or more functions described herein, such as those described herein with respect to the method of FIGS. 2-4 or other methods described herein. Memory resource 150 can, for example, be housed within the same housing as processing resource 148 for system 146, such as within a computing tower case for system 146. In some implementations, memory resource 150 and processing resource 148 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 150 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Memory resource 150 can be in communication with processing resource 148 via a communication link 158. Communication link 158 can be local or remote to a machine (e.g., a computing device) associated with processing resource 148. Examples of a local communication link 158 can include an electronic bus internal to a machine (e.g., a computing device) where memory resource 150 is one of volatile, non-volatile, fixed, and/or removable storage medium in communication with processing resource 148 via the electronic bus.

In some implementations, one or more aspects of system 146 can be in the form of functional modules that can, for example, be operative to execute one or more processes of instructions 152, 154, or 156 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of a system 146 can, for example, include one or more machine-readable storage mediums and one or more computer processors.

In view of the above, it is appreciated that the various instructions of system 146 described above can correspond to separate and/or combined functional modules. For example, instructions 152 can correspond to a “determination module” to determine whether a received data packet can use an existing flow affinity based on a comparison of metadata for the received data packet to metadata of an entry in a port mapping table, instructions 154 can correspond to an “affinity assignment module” to assign a forwarding port for a previously forwarded data packet to the received data packet to use the flow affinity when it is determined that the received data packet can use the existing flow affinity, and instructions 156 can correspond to a “non-affinity assignment module” to assign a forwarding port determined based on dynamic load balancing criteria to the received data packet when it is determined that the received data packet cannot use the existing flow affinity. It is further appreciated that a given module can be used for multiple related functions. As but one example, in some implementations, a single module can be used to both determine whether a received data packet can use an existing flow affinity based on a comparison of metadata for the received data packet to metadata of an entry in a port mapping table (e.g., corresponding to the process of instructions 152) as well as to assign a forwarding port for a previously forwarded data packet to the received data packet to use the flow affinity when it is determined that the received data packet can use the existing flow affinity (corresponding to the process of instructions 154).

FIG. 6 illustrates a machine-readable storage medium 130 including various instructions that can be executed by a computer processor or other processing resource. In some implementations, medium 130 can be housed within a LAG node (e.g., LAG node 112) or on a network switch or other forwarding device of a network (e.g., a non-LAG node, such as node 116) which receives and forwards a given data packet. In some implementations, medium 130 can be housed remotely from the forwarding device that receives and forwards the data packet. For example, medium 130 can be housed in a controller that is in wired or wireless communication with a remote LAG node 112 or other forwarding device.

For illustration, the description of machine-readable storage medium 130 provided herein makes reference to various aspects of system 146 (e.g., processing resource 148) and other implementations of the disclosure. Although one or more aspects of system 146 (as well as its corresponding instructions 152, 154, and 156) can be applied or otherwise incorporated with medium 130, it is appreciated that in some implementations, medium 130 may be stored or housed separately from such a system. For example, in some implementations, medium 130 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 130 includes machine-readable instructions 126 stored thereon to cause processing resource 148 to assign a first forwarding port for an entry in a hash-to-port mapping table to a received data packet that has a hash value matching the hash value of the entry when a port mapping age associated with the matched entry satisfies the age criteria. Instructions 126 can incorporate one or more aspects of steps 140 or instructions 154 or another suitable aspect of other implementations described herein (and vice versa).

Medium 130 includes machine-readable instructions 128 stored thereon to cause processing resource 148 to assign a second forwarding port selected based on load balancing criteria to a received data packet when a port mapping age associated with the matched entry does not satisfy the age criteria. Instructions 128 can incorporate one or more aspects of steps 140 or instructions 156 or another suitable aspect of other implementations described herein (and vice versa).

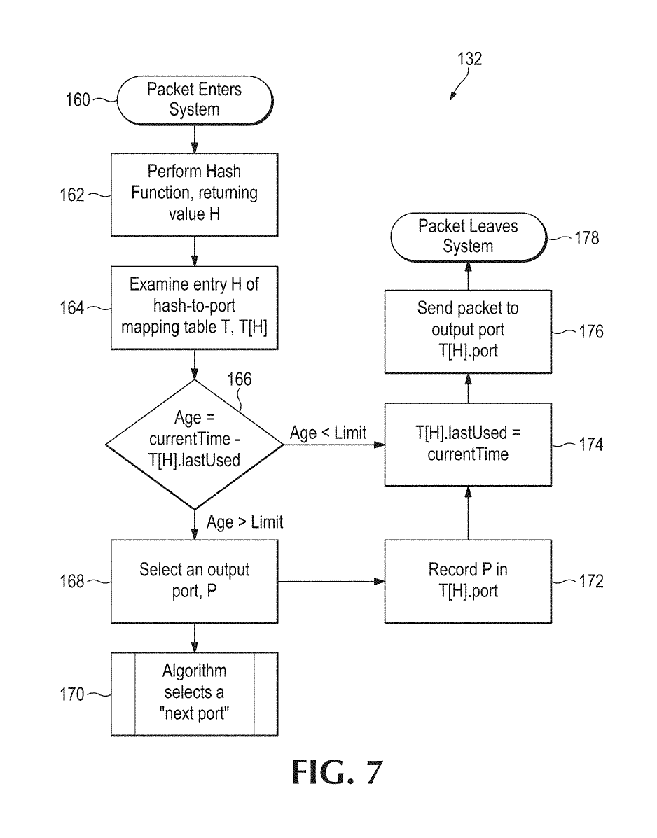

FIG. 7 is a flowchart illustrating a specific example method 132 according to the present disclosure. The description of such a specific example method is provided for illustration, however it is appreciated that aspects of method 132 are not intended to be read into other implementations of the present disclosure and the order of the various steps of method 132 are not necessarily required by this method or other methods described herein. At block 160, a packet enters the system. Next, at block 162, a hash function is performed on metadata of the received packet, returning a value “H”. At block 164, entry H of a hash-to-port mapping table T is examined (T[H]). At block 166, an age of the packet is calculated as the difference between the current time and the time that T[H] was last used (e.g., T[H].lastUsed). If the age of the packet is less than an age limit or satisfies some other age criteria, at block 174, the value for the last time that T[H] was used is set to the current time. Following block 174, at block 176, the packet is sent out an output port previously stored in the hash-to-port mapping table corresponding to T[H] (e.g., T[H].port]. At block 178, the packet leaves the system through port P. If, however, at block 166, the age of the packet is greater than an age limit or fails to satisfy some other age criteria, at block 170 an algorithm selects a next port and at block 168, output port P is selected. Next, at block 172, the selected port is assigned as the port for T[H] (T[H].port). At block 174, the value for the last time that T[H] was used is set to the current time. Following block 174, at block 176, the packet is sent out an output port stored in the hash-to-port mapping table corresponding to T[H] (e.g., T[H].port]. At block 178, the packet leaves the system through port P.

An example timeline for an implementation of method 132, which illustrates the hash-to-port table mapping at each time is provided below. At a first time event, Hash-to-Port Mapping Table (T) has 4 entries and age Limit (L) is 1 minute.

| H | lastUsed | Port |
|---|---|---|
| 0 | 07:05:20 | 3 |
| 1 | 00:00:00 | 0 |
| 2 | 07:05:01 | 4 |
| 3 | 04:40:39 | 2 |

At a second time event, a new packet enters with H=0 and currentTime=07:05:30. The age of the packet is calculated as Age=currentTime−T[0].lastUsed=10 seconds<L. Because the age of the packet is less than limit L, existing port (3) is used and the lastUsed value is updated to currentTime.

| H | lastUsed | Port |
|---|---|---|
| 0 | 07:05:30 | 3 |
| 1 | 00:00:00 | 0 |
| 2 | 07:05:01 | 4 |
| 3 | 04:40:39 | 2 |

At a third time event, a new packet enters with H=2 and currentTime=07:06:31. The age of the packet is calculated as Age=currentTime−T[2].lastUsed=1 minute, 30 seconds>L. Because the age of the packet is greater than limit L, a new port (1) is chosen for H=2 and the lastUsed value is updated to currentTime.

| H | lastUsed | Port |
|---|---|---|
| 0 | 07:05:30 | 3 |
| 1 | 00:00:00 | 0 |
| 2 | 07:06:31 | 1 |
| 3 | 04:40:39 | 2 |

At a fourth time event, a new packet enters with H=1 and currentTime=07:07:00. T[1].lastUsed is 00:00:00 due to having never been used and therefore the age of the packet is calculated as Age=currentTime−T[1].lastUsed=7 hours, 7 minutes>L. Because the age of the packet is greater than the limit L, new port (4) is chosen for H=1 and the lastUsed value is updated to currentTime.

| H | lastUsed | Port |
|---|---|---|
| 0 | 07:05:30 | 3 |
| 1 | 07:07:00 | 4 |
| 2 | 07:06:31 | 1 |
| 3 | 04:40:39 | 2 |

At a fifth time event, port 2 is removed from port pool (either manually or automatically). As a result, entries with port=2 have their lastUsed set to zero.

| H | lastUsed | Port |
|---|---|---|
| 0 | 07:05:30 | 3 |
| 1 | 07:07:00 | 4 |
| 2 | 07:06:31 | 1 |
| 3 | 00:00:00 | 2 |

As provided above, certain implementations of the systems, method, and mediums of the present disclosure can be used to add a table that maps all possible hash values to a pool of load-balanced resources, such as physical output ports in the case of a LAG. By doing so, the acts of hashing a flow's 5-tuple can be separated from selecting the specific physical link that will be used, and an additional layer of mapping logic can be provided. Furthermore, certain implementations of the present disclosure provide for the concept of aging these mappings to allow unused mappings to be recalculated in case there is a better choice for which physical link to utilize.

When manufacturing devices with this type of load balancing capability, a hardware designer could provide more or less memory for entries in the hash-to-port mapping table. The effect of increasing this table size would be increased responsiveness to changes in LAG/traffic characteristics. If a system had only 8 hash-to-port mapping table entries, those entries would be expected to be hit very frequently and therefore their age would not expire often to give an opportunity to select a new mapping. On the other hand, if a system had 8192 hash-to-port mapping table entries, each of those entries would not be expected to be hit as often, therefore increasing the probability that they would age out and select a new physical link.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
determining a hash value for a received data packet;
determining whether the determined hash value matches a hash value for an entry in a hash-to-port mapping table;
determining whether a port mapping age associated with the matched entry satisfies an age criteria; and
assigning a forwarding port for the received data packet based on the determination of whether the port mapping age associated with the matched entry satisfies the age criteria.

2. The method of claim 1, wherein the assigned forwarding port for the received data packet is a forwarding port associated with the matched entry in the hash-to-port mapping table when the port mapping age associated with the matched entry satisfies the age criteria.

3. The method of claim 1, wherein the assigned forwarding port for the received data packet is selected from a plurality of forwarding ports when the port mapping age associated with the matched entry does not satisfy the age criteria.

4. The method of claim 3, wherein the selection of a forwarding port from a plurality of forwarding ports is based on load balancing criteria.

5. The method of claim 1, wherein the age criteria is determined to provide flow affinity for data packets.

6. The method of claim 1, wherein the port mapping age associated with a given entry in the hash-to-port mapping table is a value indicating a period of time that has elapsed since a hash value for a received packet last matched a hash value in the hash-to-port mapping table for the given entry.

7. The method of claim 1, wherein the hash-to-port mapping table is stored in the form of a Ternary Content-Addressable Memory (TCAM).

8. The method of claim 1, further comprising:
forwarding the received data packet through the assigned forwarding port.

9. The method of claim 1, wherein determining a hash value for a received data packet includes performing a hashing operation on metadata of the received data packet.

10. The method of claim 1, further comprising:
determining a forwarding port for the received data packet in response to determining that a port mapping age associated with the entry satisfies the age criteria, wherein the assigned forwarding port is the same as a forwarding port associated with the entry in the table.

11. A non-transitory machine readable storage medium having stored thereon machine readable instructions to cause a computer processor to:
assign a first forwarding port for an entry in a hash-to-port mapping table to a received data packet that has a hash value matching the hash value of the entry when a port mapping age associated with the matched entry satisfies an age criteria; and
assign a second forwarding port selected based on load balancing criteria to a received data packet when a port mapping age associated with the matched entry does not satisfy the age criteria.

12. The medium of claim 11, wherein the first forwarding port is the same port as the second forwarding port.

13. A system comprising:
a processing resource; and
a memory resource storing machine readable instructions to cause the processing resource to:
determine whether a received data packet can use an existing flow affinity based on a comparison of metadata for the received data packet to metadata of an entry in a port mapping table;
assign a forwarding port for a previously forwarded data packet to the received data packet to use the flow affinity when it is determined that the received data packet can use the existing flow affinity; and
assign a forwarding port determined based on dynamic load balancing criteria to the received data packet when it is determined that the received data packet cannot use the existing flow affinity.

14. The system of claim 13, wherein the metadata is in the form of a hash value based on Transmission Control Protocol/Internet Protocol (TCP/IP) routing information.

15. The system of claim 13, wherein the machine readable instructions are to cause the processing resource to determine whether the received data packet can use an existing flow affinity based on a port mapping age of an entry in a port mapping table.
